(19) United States
(12) Patent Application Publication
(10) Pub. No.: US 2011/0264446 A1
(43) Pub. Date: Oct. 27, 2011

(54) METHOD, SYSTEM, AND MEDIA GATEWAY FOR REPORTING MEDIA INSTANCE INFORMATION

(76) Inventor: Weiwei YANG, Shenzhen (CN)

(21) Appl. No.: 13/177,975

(22) Filed: Jul. 7, 2011

Related U.S. Application Data
(63) Continuation of application No. PCT/CN2009/075455, filed on Dec. 10, 2009.

(30) Foreign Application Priority Data
Jan. 9, 2009 (CN) 200910001494.4

(51) Int. Cl. G10L 11/00; G10L 13/08

(52) U.S. Cl. 704/201; 704/270; 704/260; 704/E11.002; 704/E13.011

(57) ABSTRACT

A method, a system, and a media gateway (MG) for reporting media instance information are disclosed. The method for reporting media instance information includes: detecting, by an MG, received media data according to a set media instance detection (MID) event; and reporting, by the MG, the MID event when the media instance information is detected. With the present invention, the MG reports the detected media instance information related to the media data to a media gateway controller (MGC) through a set MID event, so that the MG can detect media instance information related to the media data, and report the detected media instance information related to the media data to the MGC. In this way, the MGC can execute corresponding control operations according to the media instance information related to the media data, extending the applicable scope of media services.

### CROSS-REFERENCE TO RELATED APPLICATIONS

This application is a continuation of International Application No. PCT/CN2009/075455, filed on Dec. 10, 2009, which claims priority to Chinese Patent Application No. 200910001494.4, filed on Jan. 9, 2009, both of which are hereby incorporated by reference in their entireties.

### FIELD OF THE INVENTION

The present invention relates to communications technologies, and in particular, to a method, a system, and a media gateway for reporting media instance information.

### BACKGROUND OF THE INVENTION

A media gateway controller (MGC) and a media gateway (MG) are two important network devices on a packet network in architecture of service-bearer separation. Under the control of the MGC, the MG can perform specified operations on media data received from other devices.

In media service applications, the MGC in the prior art cannot obtain media instance information related to the media data when the MG operates the media data. Consequently, the MGC cannot execute corresponding control operations according to the media instance information related to the media data, restricting the applicable scope of media services.

### SUMMARY OF THE INVENTION

Embodiments of the present invention provide a method, a system, and an MG for reporting media instance information, so that the MG can detect media instance information related to media data, and further report the detected media instance information to an MGC. In this way, the MGC can execute corresponding control operations according to the media instance information related to the media data, extending the applicable scope of media services.

An embodiment of the present invention further provides a method for reporting media instance information. The method includes:

detecting, by an MG, received media data according to a set media instance detection (MID) event; and

reporting, by the MG, the MID event when detecting the media instance information.

An embodiment of the present invention provides an MG. The MG includes:

a detecting module, configured to detect received media data according to a set MID event; and

a reporting module, configured to report the MID event when the detecting module detects media instance information.

An embodiment of the present invention further provides a system for reporting media instance information. The system includes.

an MG, configured to detect received media data according to a set MID event, and report the MID event to an MGC when detecting the media instance information; and

the MGC, configured to obtain the MID event reported by the MG.

According to the preceding technical solution, the MG provided in embodiments of the present invention reports the detected media instance information related to the media data to the MGC through a set MID event, so that the MG can detect media instance information related to the media data, and report the detected media instance information related to the media data to the MGC. In this way, the MGC can execute corresponding control operations according to the media instance information related to the media data, extending the applicable scope of media services.

### BRIEF DESCRIPTION OF THE DRAWINGS

To illustrate the technical solution of the present invention or in the prior art more clearly, the accompanying drawings involved in the embodiments of the present invention or in the prior art are described briefly below. Apparently, the accompanying drawings in the following description are only some embodiments of the present invention, and persons of ordinary skill in the art can derive other drawings from the accompanying drawings without creative efforts.

FIG. 1 is a flow chart of a method for reporting media instance information according to a first embodiment of the present invention;

FIG. 2 is a flow chart of a method for reporting media instance information according to a second embodiment of the present invention;

FIG. 3 is a schematic structural diagram of an MG according to a third embodiment of the present invention; and

FIG. 4 is a schematic structural diagram of a system for reporting media instance information according to a fourth embodiment of the present invention.

### DETAILED DESCRIPTION OF THE EMBODIMENTS

The technical solution of the present invention is hereinafter described in detail with reference to accompanying drawings for the embodiments. Evidently, the embodiments are exemplary only and the present invention is not limited to such embodiments. Those skilled in the art can derive other embodiments from the embodiments given herein without making any creative effort, and all such embodiments are covered in the protection scope of the present invention.

FIG. 1 is a flow chart of a method for reporting media instance information according to a first embodiment of the present invention. As shown in FIG. 1, the method includes the following steps:

Step 101: The MG detects received media data according to a set MID event.

Step 102: The MG reports the MID event when media instance information is detected.

To detect and report the media instance information over H.248, a set of event mechanism may be extended in this embodiment. The MGC may instruct the MG to track and detect played media data by sending the extended event. If the MG detects related media instance information, the MG reports the media instance information to the MGC through a notification command. The MID event may be a receiving start detection event, which is used to detect the start of receiving the media data. The MID event may also be a mark detection event, which is used to detect a mark in the media data. In addition, the MID event may include both a receiving start detection event and a mark detection event to detect the start of receiving media data and the mark in the media data.

When reporting the MID event, the MGC can further obtain related content of the media instance information by using defined event parameters, for example, mark ID information (such as a mark and an advertisement indication) of the detected mark and related time information. The MGC can decide control operations according to the obtained media instance information; for example, the MGC requests the MG to play an advertisement according to the advertisement indication mark.

In this embodiment, an event (that is, the MID event) may be defined in the H.248 protocol, so that the MG notifies the MGC of the detected media instance information related to the media data; an event parameter carried in the event may be used to indicate information related to the media instance information, for example, parameters such as the mark value of and the time value (TV) of the detected mark. The MID event may be included a current package or a newly added package. For example, the MID event may be included in an advanced audio server base package for TTS enhancement (AASTTS) in H.248.9 or a new package that may be named “playback instance information detection package (PIIDP)”.

In this embodiment, the detection of the media instance information of the media data may be applicable to multiple related operations of the media data, for example, automatic speech recognition (ASR) and audio or multimedia recording. The MGC instructs the MG to process the obtained media data; after the MG processes the media data, the MG notifies the MGC by using a signal completion event. In the process of operating the media data, when the MG detects the obtained media data, the MG may report the MID event set on the MG to the MGC. In this way, the MGC may be immediately notified that the MG detects corresponding media instance information.

In this embodiment, the media data may include voice data, or a multimedia stream, or a media file specified by a uniform resource identifier (URI), for example, a text file for executing a text to speech (TTS) operation. In this embodiment, if the media instance information related to the media data is the start of receiving the media data, the corresponding MID event is a receiving start detection event; if the media instance information related to the media data is the mark in the media data, the corresponding MID event is a mark detection event.

If the media instance information of the media data in this embodiment is the mark in the media data, the mark value of the detected mark may be an ordinary ID used to identify some data in the media data or a personalized ID set by a user to facilitate the user in querying information or tracking hot information. In addition, the mark value of the detected mark may be a specific ID used to instruct a service function or a play function to perform corresponding operations on corresponding media data, for example, pausing the media data and inserting third-party media information. The mark value parameter is a string and its value may be equivalent to the mark defined in multiple markup languages, for example, the value of the <mark> header field in a speech synthesis markup language (SSML).

If the media instance information of the media data is the mark the media data, the MID event that the MG reports to the MGC may further carry the TV parameter of the detected mark to indicate the time position information of the detected mark in the media data or other time information identifying the mark. For example, if the mark is designed in a text format, the TV parameter is the time information of the position where the mark is embedded the synthesized media data output relative to the start position or indicates the time when the mark is embedded in a synthesized voice. The value of the TV parameter is a time stamp, and may be a time value in a normal play time (NTP), that is, a 64-bit decimal number that indicates an absolute position relative to the start time.

In this embodiment, the mark value parameter and TV parameter of the mark detected by the MG may be reported separately or together in the MID event to the MGC.

It should be noted that the event parameter carried in the MID event that the MG reports to the MGC is related information used to identify and describe the detected media instance information and may be extended according to specific service requirements.

Optionally, the MID event that the MG reports to the MGC may further carry an event type (ET) parameter, where the ET parameter indicates a type of the MID event. The value of the ET parameter includes detecting the start of receiving the media data and/or detecting the mark in the media data. Specifically, the value of the ET parameter may be “Media”, indicating that the MID event is an event for detecting the start of receiving the media data, that is, the MG already starts receiving the media data. The value of the ET parameter may also be “Mark”, indicating that the MID event is an event for detecting the mark in the media data.

In this embodiment, a unified MID event is defined to detect the start of receiving media data and/or the mark in the media data. Similarly, the event for detecting the start of receiving the media data and/or the mark in the media data may be defined as two different events. For example, for a mark detection event, the definition method is the same as the preceding method for defining the MID event with the only difference in the event name. For example, the mark detection event may be named “Mark Detection” event; a separate media data start receiving event may be named “Start of Media” event. No parameters may be carried in the “Start of Media” event when the “Start of Media” event is set and reported. According to the event name, the MGC may know that the MG already detects the media data or starts receiving the media data.

In this embodiment, a step of setting the MID event may be executed before step 101. The MID event may be set on the root termination of the MG, indicating that the media instance information is detected in the media data played on the entire MG; the MID event may also be set on a specific termination (a physical termination or an ephemeral termination) on the MG, indicating that the media instance information is detected in the media data played on the specific termination. In addition, the MID event may be set on a specific stream of the MG, indicating that the MID event is only applicable to the specific stream. Specifically, two setting methods are available: pre-configuring the MID event on the MG, and sending, by the MGC, the MID event to the MG. The process of sending the MID event to the MG by the MGC may be implemented by using a lot of existing messages in the H.248 protocol. For example, the MGC sets a MID event on the MG through a Modify Request message; the MG returns a Modify Reply message to the MGC after receiving the Modify Request message. The event mechanism can be applied in a series of scenarios where multimedia services are supported, including ASR and audio or multimedia recording. In these service scenarios, the MGC sends a corresponding control instruction to the MG through a signal parameter; the MG performs corresponding operations on the received media data according to the received control instruction. In addition, the MGC may set a MID event and a signal completion event on the MG. In this case, when the MG detects the media instance information related to the media data, the MG triggers the reporting of the MID event; when the signal is executed completely, the MG reports the signal execution details through the signal completion event.

In this embodiment, the MG reports the detected media instance information related to the media data to the MGC through the MID event set on the MG. In this way, the MG can detect the media instance information related to the media data, and report the media instance information related to the media data to the MGC, so that the MGC can perform corresponding control operations according to the media instance information related to the media data, extending the applicable scope of media services.

It should be noted that the detection and reporting of the MID event do not affect the playing of the media data. For example, when the MG executes multimedia recording, the MG reports the MID event to the MGC once detecting voice data input by the user, and begins to record the data. Similarly, the detection and reporting of the mark information in the media data does not interrupt the media operations on the MG.

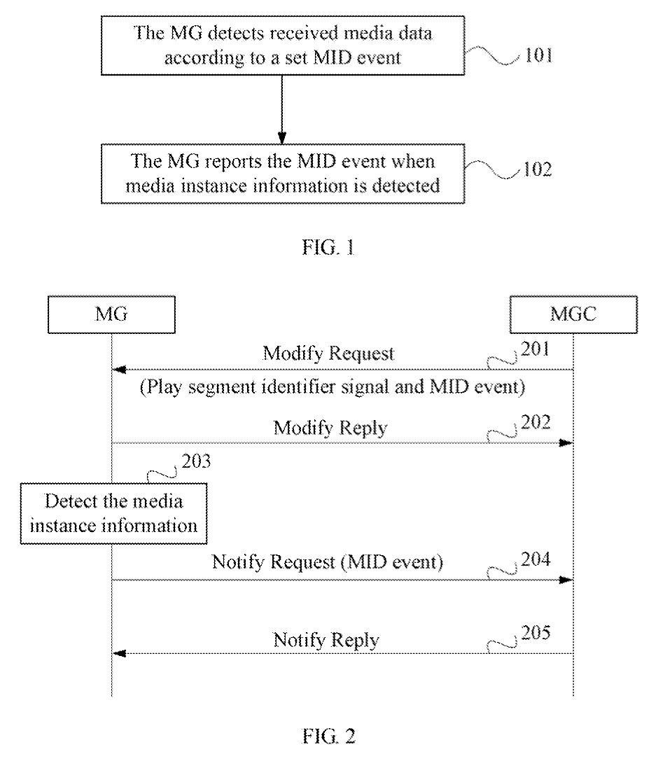

To support the application of media data (voice data) synthesis, the MGC instructs the MG to execute TTS operations on related text files by using the TTS package in the H.248.9 protocol. FIG. 2 is a flow chart of a method for reporting media instance information according to a second embodiment of the present invention. Taking the TTS application as an example, the MGC sends a play segment identifier signal to the MG by using the AASTTS package in the H.248 protocol, instructing the MG to execute TTS operations on related text files. As shown in FIG. 2, the method for reporting the media instance information in this embodiment may include the following steps:

Step 201: The MGC sends a Modify Request message to the MG, where the Modify Request message carries a play segment identifier signal and a MID event.

Step 202: The MG receives the Modify Request message, and returns a Modify Reply message to the MGC.

Step 203: The MG executes a TTS operation on the text file represented by the play segment identifier signal carried in the Modify Request message, detects the text file according to the MID event carried in the Modify Request message, and detects media instance information.

For example, the MG detects that the text file begins to be received, or the MG detects a mark in the text file.

Step 204: The MG triggers the reporting of the MID event. Specifically, the MG may report a mark detection event to the MGC through a Notify Request message.

In this step, the media instance information detected by the MG may be the start of receiving media data (namely, the text file), or be a mark in the media data. In this case, the MID event may be an event for detecting the start of receiving the media data or an event for detecting the mark in the media data.

In this step, if the MID event is a mark detection event, the MID event also needs to carry the mark values of the detected marks to indicate the mark in the media data. When the media instance information detected by the MG is the mark in the media data, the MID event that the MG reports to the MGC may further carry a mark value parameter of the detected mark. The value of the mark value parameter may be a string or in other forms, and the content of the mark value parameter may be a mark name, a personalized ID, or related indication information. For example, the value of the mark value parameter may be an action ID (“START”), a human name ID (“TOM”), an operation indication (“INSERT NO 5 AD”), or a content indication (“New Message”).

Optionally, in this embodiment, the MID event that the MG reports to the MGC may further carry an ET parameter. The value of the ET parameter may be “Media”, indicating that the MID event is an event for detecting the start of receiving the media data, that is, the MG already begins to receive the media data. The value of the ET parameter may also be “Mark”, indicating that the MID event is an event for detecting the mark in the media data.

The mark value of the preceding detected mark may be processed by a network control unit, for example, the MGC or other service processing units.

Further, when the media instance information detected by the MG is the mark in the media data, the MID event that the MG reports to the MGC may further carry a TV parameter of the detected mark. The value of the TV parameter may be a number, for example, “16039059”, indicating the tune information of the position where the mark is embedded in the synthesized media data output relative to the start position of the media data.

Step 205: The MGC receives the MID event reported through the Notify Request message, and returns a Notify Reply message to the MG. In TTS applications, the MGC may decide control operations according to the obtained media instance information. For example, if the mark value of the detected mark is “ANSWER”, it indicates that the subsequent content is answer data, and the MGC needs to send the information to a related service unit for processing.

In the message interactions between the MG and the MGC, only information related to the MID event is provided, and parameters and action commands required in procedures involved in other messages are not listed, for example, parameter information of a play segment identifier signal, and the MGC may set a signal completion detection event when sending the play segment identifier signal.

For better description of the method provided in the preceding embodiments of the present invention, the method is described as a combination of a series of actions. It is understandable to those skilled in the art that the present invention is not limited by the sequence of the actions. Some steps may be executed in other sequence or at the same time according to the present invention. In addition, it is understandable to those skilled in the art that the embodiments in the specification are exemplary embodiments and that the actions and modules involved in these embodiments are not mandatory for the present invention.

The major concerns of the preceding embodiments are different. Details are given in some embodiments but omitted in other embodiments.

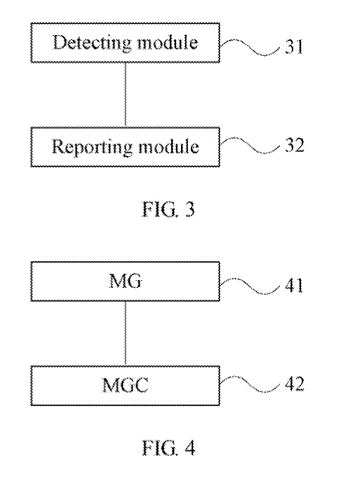

FIG. 3 is a schematic structural diagram of an MG according to a third embodiment of the present invention. As shown in FIG. 3, the MG provided in this embodiment may include a detecting module 31 and a reporting module 32. The detecting module 31 is configured to detect received media data according to a set MID event. The reporting module 32 is configured to report the set MID event that carries detected media instance information when the detecting module 31 detects the media instance information.

This MG implements the method provided in the preceding first embodiment of the present invention and the functions of the MG provided in the second embodiment of the present invention.

In this embodiment, the reporting module reports the detected media instance information related to the media data to the MGC through a set MID event. In this way, the MG can detect the media instance information related to the media data, and report the media instance information to the MGC, so that the MGC can perform corresponding control operations according to the media instance information related to the media data, extending the applicable scope of media services.

FIG. 4 is a schematic structural diagram of a system for reporting media instance information according to a fourth embodiment of the present invention. As shown in FIG. 4, the system for reporting media instance information may include an MG 41 and an MGC 42.

The MG 41 is configured to: detect received media data according to a set MID event; and when detecting the media instance information, report the MID event set on the MG 41 to the MGC 42, where the MID event carries the media instance information detected by the MG 41. The MGC 42 is configured to obtain the MID event reported by the MG 41.

The MG 41 in the system for reporting media instance information implements the method provided in the first embodiment of the present invention and the functions of the MG provided in the second embodiment and third embodiment of the present invention.

Those skilled in the art can understand that all or part of the steps of the method according to the embodiments of the present invention may be implemented by a program instructing relevant hardware. The program may be stored in a computer readable storage medium. When the program runs, the steps of the method according to the embodiments of the present invention are performed. The storage medium may be a read-only memory (ROM), a random access memory (RAM), a magnetic disk, or a compact disk-read only memory (CD-ROM).

It should be noted that the above embodiments are merely provided for describing the technical solution of the present invention, but not intended to limit the present invention. Although the present invention has been described in detail with reference to the foregoing embodiments, it is apparent that those skilled in the art can make various modifications and variations to the invention without departing from the spirit and scope of the invention. The invention shall cover the modifications and variations provided that they fall within the scope of protection defined by the appending claims or their equivalents.

What is claimed is:

1. A method for reporting media instance information, comprising:
detecting, by a media gateway (MG), received media data according to a set media instance detection (MID) event; and
reporting, by the MG, the MID event when the media instance information is detected.

2. The method according to claim 1, wherein the MID event comprises a receiving start detection event and/or a mark detection event.

3. The method according to claim 2, wherein when the MID event is the mark detection event, the reported MID event further carries a mark value and/or a time value (TV) of a detected mark.

4. The method according to claim 2, wherein the MID event is set on a root termination of the MG, a physical termination of the MG, an ephemeral termination of the MG, or a specified stream of the MG.

5. The method according to claim 1, wherein the media instance information comprises start of receiving the media data and/or a mark in the media data.

6. The method according to claim 1, wherein the MID event carries an event type (ET) parameter, wherein the ET parameter indicates a type of the MID event, and a value of the ET parameter comprises detecting the start of receiving the media data and/or the mark in the media data.

7. The method according to claim 1, further comprising: sending the MID event to the MG or configuring the MID event on the MG.

8. The method according to claim 1, wherein the media data comprises voice data, a media stream, or a media file corresponding to a unified resource identifier (URI).

9. The method according to claim 1, wherein the media data comprises a text file for executing a text to speech (TTS).

10. The method according to claim 3, wherein when the MID event is the mark detection event, the mark value of the detected mark comprises an ordinary ID used to identify some data in the media data, or a personalized ID set by a user to facilitate the user in querying information or tracking hot information, or a specific ID used to instruct a service function or a play function to perform corresponding operations on corresponding media data.

11. A media gateway (MG), comprising:
a detecting module, configured to detect received media data according to a set media instance detection (MID) event; and
a reporting module, configured to report the MID event when the detecting module detects media instance information.

12. The MG according to claim 11, wherein the MID event comprises a receiving start detection event and/or a mark detection event.

13. The MG according to claim 12, wherein when the MID event is the mark detection event, the reported MID event further carries a mark value and/or a time value (TV) of a detected mark.

14. A system for reporting media instance information, comprising a media gateway (MG) and a media gateway controller (MGC), wherein:
the MG is configured to detect received media data according to a set media instance detection (MID) event, and report the MID event to the MGC when the media instance information is detected; and
the MGC is configured to obtain the MID event reported by the MG.

15. The system according to claim 14, the MGC is further configured to send the MID event to the MG.
